(19) United States
(12) Patent Application Publication
(10) Pub. No.: US 2004/0114824 A1
(43) Pub. Date: Jun. 17, 2004

(54) Method of adjusting the level of a specimen surface

(76) Inventors: Riki Ogawa, Kawasaki-shi (JP); Mitsuo Tabata, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/666,241

(22) Filed: Sep. 22, 2003

(30) Foreign Application Priority Data
Sep. 30, 2002 (JP) 2002-285541

(51) Int. Cl. G06K 9/40; G06K 9/00

(52) U.S. Cl. 382/255; 382/141

(57) ABSTRACT

A specimen surface level adjusting method used in a pattern inspecting apparatus for inspecting a pattern on a specimen surface on the basis of a detected image obtained by projecting inspecting light onto the specimen surface, the specimen surface level adjusting method comprising projecting level measuring light onto the specimen surface, detecting the position of the measuring light reflected on the specimen surface, calculating the level of the specimen surface on the basis of the position of the optical axis, adjusting the level of the specimen surface so that the calculated level may be held within the depth of focus of a pattern inspecting optical system, detecting the intensity of the reflected light, and fixing the specimen surface to a reference level, if the intensity is less than a specific threshold value.

### CROSS-REFERENCE TO RELATED APPLICATIONS

This application is based upon and claims the benefit of priority from the prior Japanese Patent Application No. 2002-285541, filed Sep. 30, 2002, the entire contents of which are incorporated herein by reference.

### BACKGROUND OF THE INVENTION

1. Field of the Invention

This invention relates to a method of adjusting the level of a specimen surface in real time, when a pattern formed on a specimen, such as a reticule or a mask, is inspected by a pattern inspecting apparatus. More particularly, this invention relates to a method of adjusting the level of the surface of a specimen with a pellicle to be inspected.

2. Description of the Related Art

Photolithographic techniques are used to manufacture semiconductor devices, such as ICs (Integrated circuits) or LSIs (Large-Scale Integration). When there is a defect in a photomask used in these techniques, the yield in the manufacturing processes decreases. To overcome this problem, a pattern inspecting apparatus for checking a mask for defects has been developed and put to practical use.

In recent years, a mask has been protected with a pellicle to prevent infinitesimal dust from adhering to the surface of the mask. A pellicle is a thin film of several micrometers in thickness stuck to a pellicle frame. When used, a pellicle is fixed (or stuck) to a glass substrate on which a pattern has been formed. It is important to use a pattern inspecting apparatus to check not only a mask alone but also a mask with a pellicle.

The pattern inspecting apparatus detects a defect by projecting inspecting light onto the surface of the mask by means of an inspection optical system. Therefore, an autofocus mechanism of focusing the inspection optical system on the surface of the mask is indispensable. The autofocus mechanism is realized by detecting the level of the mask and controlling the position so that the position may be kept at the focal point of the objective. A piezoelectric element capable of minute driving is used to drive the mask in the direction of level.

The most widely used method of detecting the level of the mask is to project measuring light onto the mask and detect fluctuations in the optical axis of the reflected light. For instance, light is projected diagonally onto the mask. Fluctuations in the optical axis of the reflected light are detected by a sensor, thereby computing the level of the mask. Then, the mask is moved up and down so as to make the mask level signal constant.

When the mask is provided with a pellicle, there may be a position where the measuring light is blocked out by the pellicle. In such a position, the level of the mask cannot be calculated, which makes it impossible to adjust the level of the mask.

As described above, in the existing inspecting method, the level of the mask may be impossible to adjust at a specific position from the pellicle frame. In such a case, the region where a mask with a pellicle can be inspected is smaller than the region where a mask without a pellicle can be inspected. That is, only the region distant from the pellicle frame can be inspected. The size of the pellicle frame and the size of the region where a pattern is formed are determined by the design of the device and the peripheral devices, including a stepper. Therefore, it has been desired that the region where a mask with a pellicle can be inspected should be expanded without degrading the high sensitivity.

### BRIEF SUMMARY OF THE INVENTION

An object of the present invention is to provide a specimen surface level adjusting method capable of expanding the region where a specimen with a pellicle can be inspected, without impairing the inspection sensitivity.

According to an aspect of the present invention, there is provided a specimen surface level adjusting method used in a pattern inspecting apparatus for inspecting a pattern on a specimen surface on the basis of a detected image obtained by projecting inspecting light onto the specimen surface, the specimen surface level adjusting method comprising: projecting level measuring light onto the specimen surface; detecting the position of the measuring light reflected on the specimen surface; calculating the level of the specimen surface on the basis of the position of the optical axis; adjusting the level of the specimen surface so that the calculated level may be held within the depth of focus of a pattern inspecting optical system; detecting the intensity of the reflected light; and fixing the specimen surface to a reference level, if the intensity is less than a specific threshold value.

With such a configuration, the quantity of reflected light of the level measuring light is monitored. According to the result of the monitoring, whether the movement control of a specimen is performed or stopped by an up-and-down moving mechanism is determined. That is, when the level measuring light is blocked out by the pellicle, the movement of the specimen by the moving mechanism is stopped. This prevents the position of the specimen surface from deviating significantly from the focal point of the pattern inspecting optical system.

Therefore, in the pattern inspecting apparatus for inspecting a defect in the pattern on the specimen, it is possible to adjust the level of the specimen surface in a wider region, even when a specimen with a pellicle is used. It is further possible to contribute to inspecting patterns with higher sensitivity and higher precision.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a block diagram of a pattern inspecting apparatus according to a first embodiment of the present invention;

FIG. 2 is a sectional view of the mask 13 in FIG. 1;

FIG. 3 is a block diagram showing a configuration of the autofocus unit 17 in FIG. 1;

FIG. 4 is a conceptual diagram showing the configuration of a mechanism for detecting the level of the mask 13 in the pattern inspecting apparatus of FIG. 1;

FIG. 5 shows the configuration of the bisected sensor 34;

FIG. 6 is a diagram to help explain the relationship between the level of the mask and the detected signal outputted from the bisected sensor 34;

FIG. 7 shows the relationship between a fluctuation in the position of the mask and the driving position of the piezoelectric element in the first embodiment;

FIG. 8 is a diagram to help explain a problem encountered in the existing position adjusting method;

FIG. 9 shows the relationship between a fluctuation in the position of the mask and the driving position of the piezoelectric element 33 in the existing position adjusting method; and

FIG. 10 is a block diagram showing a configuration of an autofocus unit 17 used in a pattern inspecting apparatus according to a second embodiment of the present invention.

### DETAILED DESCRIPTION OF THE INVENTION

Hereinafter, referring to the accompanying drawings, embodiments of the present invention will be explained.

### First Embodiment

FIG. 1 is a block diagram of a pattern inspecting apparatus according to a first embodiment of the present invention. In FIG. 1, inspecting light emitted from a light source 11 is projected on a mask 13 via an illumination optical unit 12. The mask 13, which is a specimen to be inspected, is placed above an x-y stage unit 16 with a piezoelectric element 33 between the mask 13 and the stage unit 16.

The light passed through the mask 13 forms an image on the imaging element or the like of a detecting unit 15 via an image forming optical system 14 including an objective. The detected image from the detecting unit 15 is compared with a reference image at a comparator unit 18. A point at which the detected image disagrees with the reference image is detected as a defect. The mask 13 is scanned two-dimensionally in directions crossing the optical axis at right angles as a result of the movement of the x-y stage unit 16. The entire pattern on the mask 13 is inspected by scanning the whole surface of the mask 13.

An autofocus (AF) unit 17 holds the level of the mask 13 (more specifically, the level of the pattern formation face of the mask 13) at the focal point position (that is, within the depth of focus) of the objective of the image forming optical system 14. An inspection control unit 19 supervises control of the x-y stage unit 16, autofocus unit 17, detecting unit 15, comparator unit 18, and others. The pattern is inspected under the control of the inspection control unit 19.

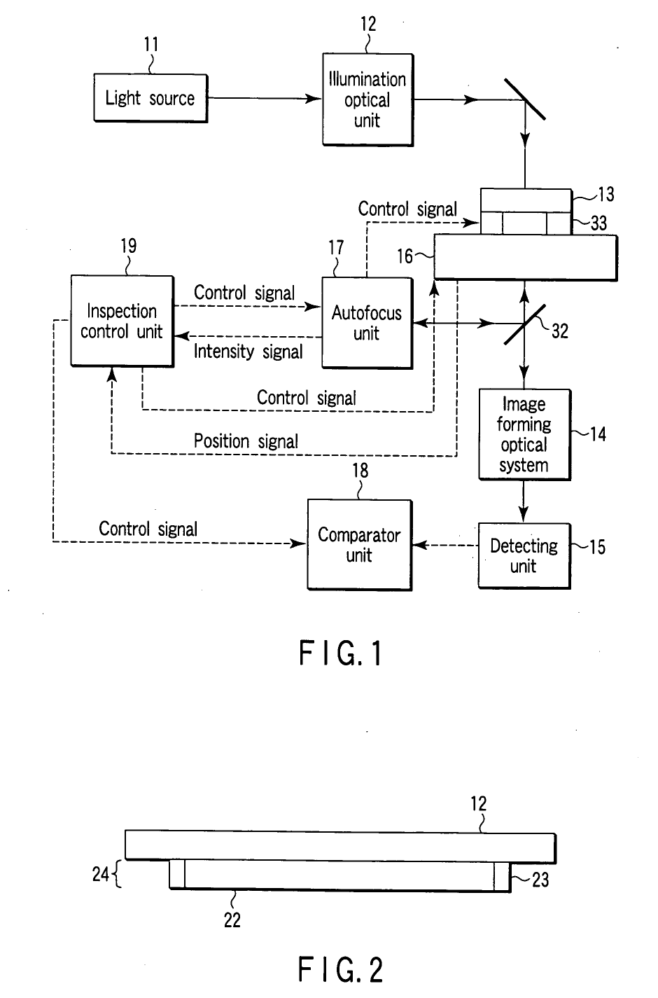

FIG. 2 is a sectional view of the mask 13 in FIG. 1. The mask 13 has a glass substrate 21 and a pellicle 24. On the surface of the glass substrate 21 (the undersurface in the figure), an LSI pattern is formed. The pellicle 24 includes a pellicle frame 23 fixed to the glass substrate 21 and a thin film 22 of several millimeters in thickness stuck to the pellicle 23. The pellicle 24 prevents dust from adhering to the pattern formation face of the mask 13. The pellicle frame 23 is fixed outside the pattern region in such a manner that the frame 23 encloses the pattern region.

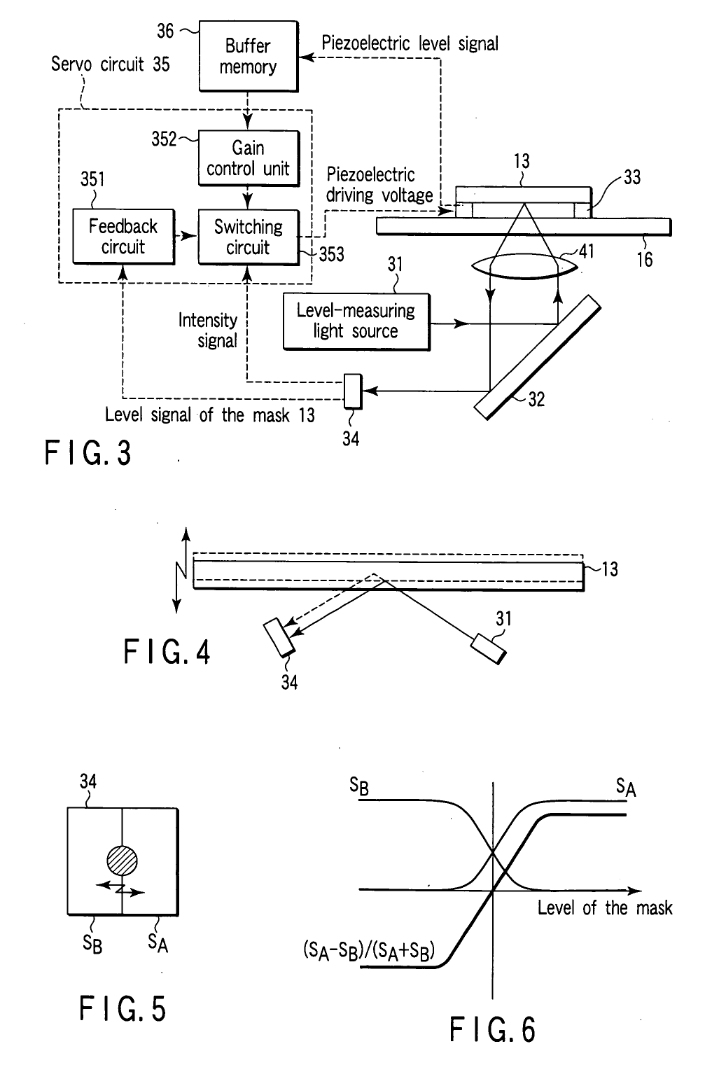

FIG. 3 is a block diagram showing a configuration of the autofocus unit 17 in FIG. 1. FIG. 3 shows the autofocus unit of the TTL optical lever type. In this invention, another type of autofocus unit may be used. To prevent the effect of the inclination or deflection of the mask, the autofocus light has to be projected within the visual field of the optical sensor. The system in which the optical axis of the autofocus light is caused to pass through the objective is referred to as TTL. The system in which the optical axis is not caused to pass through the objective is referred to as non-TTL.

In FIG. 3, the mask 13 placed on the x-y stage unit 16 is moved in the z-direction (in the direction of level) by the piezoelectric element 33 acting as a moving mechanism. The measuring light emitted from a level-measuring light source 31 is reflected by a dichroic mirror 32, passes through an objective 41, and is projected on the mask 13. The light reflected by the mask 13 passes through the objective 41 again, is reflected by the dichroic mirror 32, and enters a bisected sensor 34. When the level of the mask 13 changes as a result of the movement of the x-y stage unit 16 or the like, the optical axis of the light entering the bisected sensor 34 shifts. Therefore, the level of the mask 13 can be detected from the output of the bisected sensor 34.

The bisected sensor 34 acting as a position sensor has two photodiodes (not shown). Light enters the two photodiodes so as to extend over them. Let the output of one photodiode be S_{A} and the output of the other photodiode be S_{B.} The ratio of S_{A} to S_{B} varies according to the movement of the optical axis. Therefore, the position of the light can be detected by calculating (S_{A}−S_{B})/(S_{A}+S_{B}).

The detected signal from the bisected sensor 34 is supplied to a servo circuit 35. The servo circuit 35 includes a feedback circuit 351, a gain control unit 352, and a switching circuit 353. The servo circuit 35 provides servo control of the piezoelectric element 33 in such a manner that the level signal of the mask 13 obtained from the bisected sensor 34 is kept constant.

The level signal of the mask 13 outputted from the bisected sensor 34 is inputted to the feedback circuit 351. On the basis of the level signal, the feedback circuit 351 outputs a piezoelectric driving voltage for driving the piezoelectric element 33. The piezoelectric level signal outputted from the piezoelectric element 33 is inputted to the buffer memory 36. Instead of the piezoelectric level signal, a piezoelectric applied voltage may be used.

The buffer memory 36 stores the piezoelectric level signal for a specific period of time. Then, the time average value of or the last value of the piezoelectric level is outputted to the gain control unit 352. The gain control unit 352 converts the piezoelectric level signal into a piezoelectric applied voltage and outputs the converted value to the switching circuit 353. When the piezoelectric applied voltage is recorded in the buffer memory 36, the gain is one. As a result, the gain control circuit 352 is unnecessary.

The output of the feedback circuit 351 and that of the gain control unit 352 are supplied to the piezoelectric element 33 via the switching circuit 353. The switching circuit 353 selectively outputs any one of the signals according to the intensity signal detected by the bisected sensor 34. Specifically, if the intensity signal detected by the bisected sensor 34 is equal to or larger than a predetermined threshold value, the switching circuit 353 selects the output signal from the feedback circuit 351. If the intensity signal is smaller than the predetermine threshold value, the switch circuit 353 selects the output signal of the gain control unit 352.

FIG. 4 is a conceptual diagram showing the configuration of a mechanism for detecting the level of the mask 13 in the pattern inspecting apparatus of FIG. 1. As shown in FIG. 4, the output light from the level measuring light source 31 is caused to enter the undersurface of the mask diagonally. A change in the optical axis of the reflected light is detected by the bisected sensor 34. On the basis of the detected signal from the bisected sensor 34, the level of the mask is calculated.

FIG. 5 shows the configuration of the bisected sensor 34. The bisected sensor 34 includes a photodiode that produces a photoelectric conversion output S_{A} and a photodiode that produces a photoelectric conversion output S_{B}. The levels of the outputs S_{A,} S_{B} are proportional to the intensity of the light incident on the respective photodiodes.

FIG. 6 is a diagram to help explain the relationship between the level of the mask and the detected signal outputted from the bisected sensor 34. In FIG. 6, the level of the mask corresponds to the position of the light entering the bisected sensor 34. The position of the light is determined by calculating (S_{A}−S_{B})/(S_{A}+S_{B}).

Next, a method of inspecting the mask 13 with the pattern inspecting apparatus configured as described above will be explained. A method of adjusting the level of the mask 13 will be particularly explained in detail.

In FIG. 1, the inspecting light from the light source 11 is projected on the mask 13. The passing-through light is detected by the detecting unit 15. The detected image of the passing-through light is compared with the prepared reference image at the comparator unit 18, thereby determining whether there is a defect in the pattern. The mask 13 is scanned in the x-direction and y-direction by the x-y stage unit 16, thereby inspecting the entire surface of the mask 13.

In inspecting the pattern, the pattern formation face of the mask 13 has to be held within the depth of focus of the objective lens 41 of the image forming optical system 14. That is, automatic focusing is necessary. For this reason, the level of the mask 13 is adjusted by the autofocus unit 17 and piezoelectric element 13.

In the first embodiment, the servo circuit 35 of the autofocus unit 17 (in FIG. 3) monitors the intensity signal (S_{A}+S_{B}) of the bisected sensor 34. When the intensity signal is equal to or larger than the threshold value, the servo circuit 35 acts so as to hold the level of the mask constant. As a result, the position of the surface of the mask 13 is kept so as to be within the depth of focus of the objective 41 all the time. Therefore, a defect in the pattern of the mask 13 can be inspected with high accuracy. If the threshold value of the intensity signal is made sufficiently smaller than the reflectivity of the glass substrate 21, feedback control can be prevented from stopping in the region where the pellicle frame 23 does not exist.

When the pellicle frame 23 on the mask 13 blocks out the level measuring light, the detected amount of light at the bisected sensor 34 becomes equal to or less than the threshold value. In this case, the servo circuit 35 stops the servo driving. When the pellicle frame 23 blocks out the level measuring light, the quantity of light entering the bisected sensor 34 becomes zero. That is, at the position where (S_{A}+S_{B})=0, the servo driving is stopped. At this time, the position of the piezoelectric element 33 is fixed to the position immediately before the servo driving is stopped or to the average position in a specific period of time before the servo driving is stopped. That is, when the servo driving is stopped, the driving of the piezoelectric element 33 is stopped. The position of the piezoelectric element 33 is fixed to any one of the position immediately before the stopping of the servo driving and the average position in a specific period of time before the stopping of the servo driving.

The reference value of the position to which the piezoelectric element 33 is to be fixed is given from the buffer memory 36 to the servo circuit 35. The servo circuit 35 applies a voltage to the piezoelectric element 33 so that its level may reach the reference value. Information about the level of the piezoelectric element 33 is measured by a position sensor (not shown) built in the piezoelectric element 33. Information about the level in a given length of time is stored in the buffer memory 36, while being updated constantly. The servo circuit 35 reads the latest level information or the average level information for a specific period of time from the buffer memory 36.

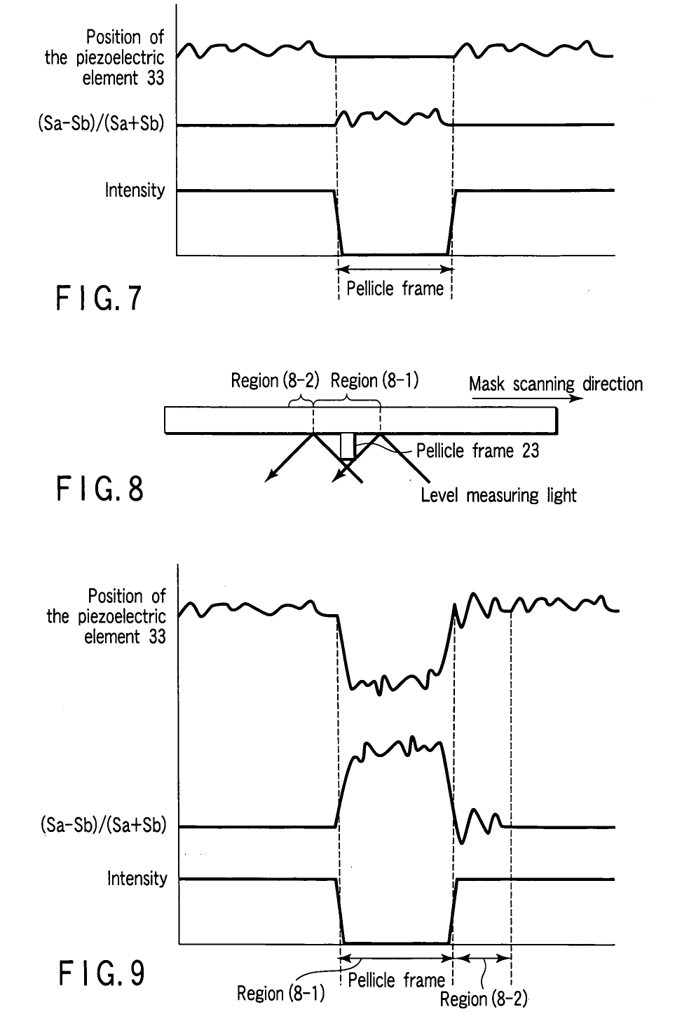

FIG. 7 shows the relationship between a fluctuation in the position of the mask and the driving position of the piezoelectric element 33 in the first embodiment. In FIG. 7, a fluctuation in the intensity, the position of the piezoelectric element 33, and a fluctuation in the level of the mask are shown with respect to the passage of time when the level measuring light crosses the pellicle frame 23. FIG. 7 shows a case where the reference position of the piezoelectric element 33 is set as the average position in a specific period of time before the servo driving is stopped.

As shown in FIG. 7, when the level measuring light crosses the pellicle frame 23, the driving of the servo circuit 35 is stopped, thereby fixing the position of the piezoelectric element 33. Thus, the level of the mask 13 can be held at the focal point position of the objective 41, which minimizes a shift in focus at the position of the pellicle frame. Moreover, it is possible to minimize the time required to return to the servo driving after the level measuring light passes the pellicle frame 23. The same effect can be obtained even in a case where the reference position of the piezoelectric element 33 is set as the position immediately before the servo driving is stopped.

FIG. 8 is a diagram to help explain a problem encountered in the existing position adjusting method. As shown in FIG. 8, the level measuring light is blocked out by the pellicle frame 23 in region (8-1), which prevents light from entering the bisected sensor 34. That is, since the denominator of (S_{A}−S_{B})/(S_{A}+S_{B}) is zero, the output signal of the bisected sensor 34 takes an abnormal value. The servo system tries to control the position of the piezoelectric element 33 on the basis of the abnormal signal, with the result that the level of the mask 13 moves significantly away from the focal point position of the objective 41 in region (8-1).

FIG. 9 shows the relationship between a fluctuation in the position of the mask and the driving position of the piezoelectric element 33 in the existing position adjusting method. As shown in FIG. 9, control of the position of the piezoelectric element 33 becomes unstable in region (8-1), resulting in a large fluctuation in the level of the mask 13.

In FIG. 8, a certain length of time is needed to restore the servo driving from the position distant from the focal point position. Therefore, even in region (8-2), the mask 13 has not returned to the focal point position completely. That is, in region (8-1) and region (8-2) in FIGS. 8 and 9, the picture quality deteriorates due to a shift in the focal point, with the result that the pattern on the specimen cannot be inspected accurately.

In contrast, with the first embodiment, when the level measuring light is blocked out by the pellicle frame 23, the blockage is detected and the servo driving is stopped. This prevents the mask 13 from deviating significantly from the focal point position of the objective 41.

Specifically, the autofocus unit 17 monitors the value of (S_{A}+S_{B}). When the value becomes equal to or less than the threshold value, the servo control is stopped and the piezoelectric element 33 is fixed to the reference position. Then, when the value of (S_{A}+S_{B}) is larger than the threshold value, the servo control is resumed. Use of such control prevents the level of the mask 13 from deviating significantly from the focal point position of the objective 41. This makes it possible to adjust the level of the mask 13 accurately in a wider region even when the mask 13 with a pellicle is used. As a result, it is possible to contribute to inspecting patterns with higher sensitivity and higher accuracy.

### Second Embodiment

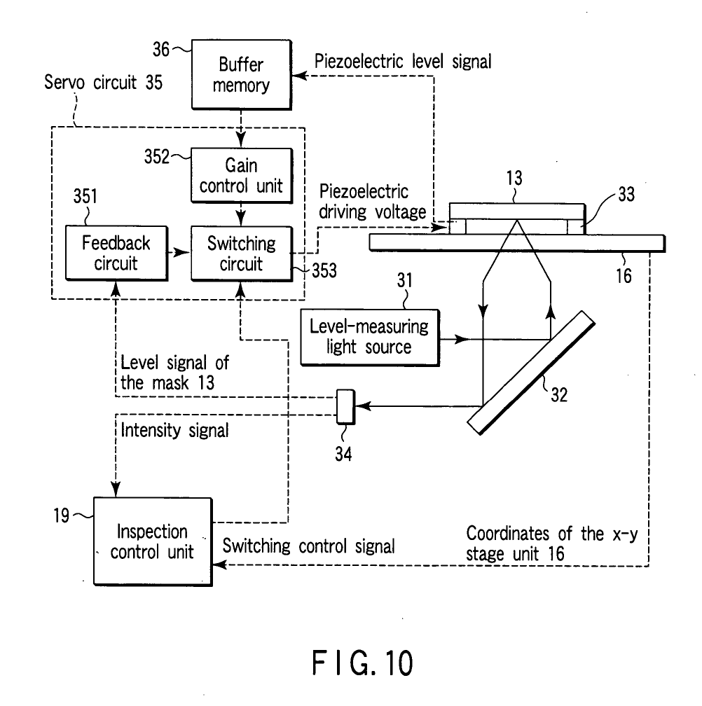

FIG. 10 is a block diagram showing a configuration of an autofocus unit 17 used in a pattern inspecting apparatus according to a second embodiment of the present invention. In FIG. 10, the same parts as those in FIG. 3 are indicated by the same reference numerals. Only what is different from FIG. 3 will be explained.

In FIG. 10, the basic configuration of the pattern inspecting apparatus is the same as that of FIG. 1 except for the configuration of the autofocus unit 17. Specifically, the intensity signal obtained at the bisected sensor 34 is supplied to the inspection control unit 19, not to the switching circuit 353 of the servo circuit 35. Then, the inspection control unit 19 provides switching control of the switching circuit 353 in the servo circuit 35.

In the second embodiment, before inspecting the pattern, the inspection control unit 19 scans the x-y stage unit 16, while monitoring the output signal (S_{A}+S_{B}) of the bisected sensor 34. Then, the inspection control unit 19 records the coordinates of the x-y stage unit 16 at which (S_{A}+S_{B}) becomes equal to or less than the threshold value as the coordinates of the position of the pellicle 24. The coordinates of the x-y stage unit 16 are measured by a sensor, such as a laser interferometer attached to the stage unit 16.

When pattern inspection is started, the inspection control unit 19 controls the autofocus unit 17 before the previously recorded coordinates of the pellicle position are reached, thereby stopping the servo control. At this time, the inspection control unit 19 fixes the level of the piezoelectric element 33 to the level immediately before the servo control is stopped or to the average level in a specific period of time before the servo control is stopped. Then, when the coordinates of the pellicle position are passed, the inspection control unit 19 controls the autofocus unit 17 to resume the focus servo control.

As described above, in the second embodiment, before pattern inspection, the position at which light will be blocked out by the pellicle frame 23 is measured in advance. This makes it possible to stop the action of the focus servo control a little before light is actually blocked out. In the first embodiment, since the servo control is stopped after light starts to be actually blocked out, the position of the mask can shift in the meantime. In the second embodiment, this drawback is overcome.

The present invention is not limited to the first and second embodiments. While in the first and second embodiments, the level measuring optical unit is of the TTL type, it may be of the non-TTL type. The level measuring position sensor is not limited to a bisected sensor. It may be any sensor, provided that the sensor can measure a shift in the optical axis of the reflected light from a specimen to be inspected, in the form of a change in an electric signal. Furthermore, the moving mechanism of moving the specimen in the direction of level is not limited to a piezoelectric element. It may be any device, provided that the device can move the specimen in quick response to a fluctuation in the level of the surface of the specimen caused by the movement of the stage.

In addition, while in the embodiments, the light passed through the specimen to be inspected has been used for pattern inspection, the reflected light from the specimen may be used. Moreover, the specimen to be inspected is not necessarily limited to the mask. For instance, a recitle or another specimen may be used. This invention may be practiced or embodied in still other ways without departing from the spirit or essential character thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A specimen surface level adjusting method used in a pattern inspecting apparatus for inspecting a pattern on a specimen surface on the basis of a detected image obtained by projecting inspecting light onto the specimen surface, the specimen surface level adjusting method comprising:
projecting level measuring light onto the specimen surface;
detecting the position of the measuring light reflected on the specimen surface;
calculating the level of the specimen surface on the basis of the position of the optical axis;
adjusting the level of the specimen surface so that the calculated level may be held within the depth of focus of a pattern inspecting optical system;
detecting the intensity of the reflected light; and
fixing the specimen surface to a reference level, if the intensity is less than a specific threshold value.

2. The specimen surface level adjusting method according to claim 1, wherein the measuring light is projected diagonally onto the specimen surface.

3. The specimen surface level adjusting method according to claim 1, wherein the reference level is the level immediately before the specimen surface is fixed.

4. The specimen surface level adjusting method according to claim 1, wherein the reference level is the average value of the level in a specific period of time before the specimen surface is fixed.

5. The specimen surface level adjusting method according to claim 1, wherein
the reflected light is caused to enter an optical sensor including a plurality of photoelectric conversion elements, and
at least one of the position of the optical axis and the intensity is detected by monitoring the photoelectric conversion output of each of said plurality of photoelectric conversion elements.

6. The specimen surface level adjusting method according to claim 1, wherein
a specimen having the specimen surface is placed on a piezoelectric element, and
the level of the specimen surface is adjusted by a voltage applied to the piezoelectric element.

7. A specimen surface level adjusting method used in a pattern inspecting apparatus for inspecting a pattern on a specimen surface on the basis of a detected image obtained by projecting inspecting light onto the specimen surface, the specimen surface level adjusting method comprising:
projecting first measuring light for level measurement onto the whole of the specimen surface;
detecting the intensity of the reflected light of the first measuring light;
recording position information about projected position where the intensity is less than a specific threshold value;
projecting second measuring light for level measurement onto the specimen surface;
detecting the position of the optical axis of the reflected light of the second measuring light;
calculating the level of the specimen surface on the basis of the position of the optical axis;
adjusting the level of the specimen surface so that the calculated level may be held within the depth of focus of a pattern inspecting optical system; and
fixing the level of the specimen surface to a reference level at the projected position corresponding to the recorded position information.

8. The specimen surface level adjusting method according to claim 7, wherein the first and second measuring lights are projected from a single light source diagonally onto the specimen surface.

9. The specimen surface level adjusting method according to claim 7, wherein the reference level is the level immediately before the specimen surface is fixed.

10. The specimen surface level adjusting method according to claim 7, wherein the reference level is the average value of the level in a specific period of time before the specimen surface is fixed.

11. The specimen surface level adjusting method according to claim 7, wherein
the reflected lights of the first and second measuring lights are caused to enter an optical sensor including a plurality of photoelectric conversion elements, and
at least one of the position of the optical axis and the intensity is detected by monitoring the photoelectric conversion output of each of said plurality of photoelectric conversion elements.

12. The specimen surface level adjusting method according to claim 7, wherein
a specimen having the specimen surface is placed on a piezoelectric element, and
the level of the specimen surface is adjusted by a voltage applied to the piezoelectric element.
